(19) United States
(12) Patent Application Publication
(10) Pub. No.: US 2010/0310235 A1
(43) Pub. Date: Dec. 9, 2010

(54) Subtitle information analysis apparatus and subtitle information analysis method

(75) Inventor: Akihito Masumura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/800,297

(22) Filed: May 12, 2010

(30) Foreign Application Priority Data
Jun. 4, 2009 (JP) P2009-134925

(51) Int. Cl. H04N 5/92

(52) U.S. Cl. 386/244; 386/E05.026

(57) ABSTRACT

Disclosed herein is a subtitle information analysis apparatus including a separator configured to separate subtitle data including bitmap data indicative of at least one of a character and a symbol; a storage configured to store a bit pattern of sample bitmap data indicative of at least one of a character and a symbol and information represented by the sample bitmap data by relating the bit pattern with the information; an estimator configured to estimate sample bitmap data substantially identical to the bitmap data from among the sample bitmap data by comparing a bit pattern of the bitmap data with a bit pattern of the sample bitmap data; and a replacer configured to replace the bitmap data by information represented by the sample bitmap data estimated identical by the estimator.

### CROSS-REFERENCE TO RELATED APPLICATION

The present application claims priority from Japanese Patent Application No. JP 2009-134925 filed in the Japanese Patent Office on Jun. 4, 2009, the entire content of which is incorporated herein by reference.

### BACKGROUND OF THE INVENTION

1. Field of the Invention

The present invention relates to a subtitle information analysis apparatus and a subtitle information analysis method.

2. Description of the Related Art

The recent popularization of video recording devices, such as hard disk recorders having mass-storage video recording media, for example, has made it a general practice to store moving-image content of very large quantities and long durations of time in each of these video recording devices. However, most users are limited in time for viewing recorded moving-image content, it is demanded for these video recording devices to allow users to view moving-image content efficiently in a short time.

On the other hand, in the case of terrestrial digital broadcasting, services are provided for people with hearing difficulties and aged people to display speeches and comments in programs on air in the form of subtitles, namely, so-called subtitled broadcasting services. The subtitles in this case are transmitted as included in moving-image streams as subtitle data from broadcasting organizations. In this connection, by use of these subtitle data, attempts are being made to execute program information analysis, search for content stored in video recording devices, and scene search in moving images, for example.

However, it should be noted here that subtitle data transmitted on terrestrial digital broadcasting include so-called DRCS (Dynamically Re-definable Character Set) that represents, in bit map data, external characters that are based on the standards of teletext broadcasting and data broadcasting character encoding, in addition to ordinary characters. DRCS is a bitmap representation of characters or symbols and used for various applications.

For example, [symbol] (- that is a kanji numeral) shown in FIG. 1A and [symbol] (denoting “mouth” in kanji) shown in FIG. 1B can be displayed in ordinary characters; but they may be expressed by DRCS in consideration of a display state on the screen. In addition to these examples, characters such as [symbol] [symbol] and so on may be expressed by DRCS. Also, those characters which cannot be expressed by an ordinary character set, such as [symbol] for example, may be expressed by DRCS. Further, in addition to character representation, DRCS is used to display symbols that represent the kind of a scene currently in moving images. For example, in a scene where music is being played, [symbol] (a musical note) that is in the DRCS expressing that music is being played as shown in FIG. 1C. In a talk scene in the case of a mobile phone, a symbol representative of a mobile phone as shown in FIG. 1D is displayed. In addition, symbols, such as a microphone shown in FIG. 1E and a television set shown in FIG. 1F, are used, for example.

Because DRCS contains external characters that are redefinable, DRCS may differ from program to program or among broadcasting organizations that transmit broadcast content data, unlike ordinary characters. Therefore, DRCS, as it is, cannot be used for content search and scene search based on subtitle data.

In order to overcome this problem, a moving-image scene type determination apparatus is proposed that is configured to determine matching between the shapes of external characters in subtitle data contained in a moving-image stream by means of pixel matching and the shapes of external characters stored in a database and then determine the scene type of the moving-image stream on the basis of audio data (refer to Japanese Patent Laid-open No. 2008-269460).

### SUMMARY OF THE INVENTION

However, it should be noted here that the moving-image scene type determination apparatus disclosed in Japanese Patent Laid-open No. 2008-269460 executes the determination of difference between the character shapes of external characters only by means of pixel matching. Consequently, although [symbol] (- that is a kanji numeral), [symbol] (a prolonged sound symbol), and “-” (hyphen) are different characters, the number of pixels of these characters almost match each other, so that these characters may be determined to be identical. Therefore, this moving-image scene determination apparatus may not execute precision scene type determination based on the subtitle data including DRCS.

In addition, the above-mentioned moving-image scene type determination apparatus determines difference between the character shapes of external characters by means of pixel matching and then executes scene type determination based on audio data, so that the number of parts for audio processing of the moving-image scene type determination apparatus increases, thereby pushing up the cost of the manufacturing of this apparatus.

Therefore, the present invention addresses the above-identified and other problems associated with related-art methods and apparatuses and solves the addressed problems by providing a subtitle information analysis apparatus and a subtitle information analysis method that are configured to analyze subtitle information with a high degree of accuracy, by replacing DRCS included in the subtitle data by ordinary characters.

In carrying out the invention and according to one mode thereof, there is provided a subtitle information analysis apparatus including separation means for separating subtitle data including bitmap data indicative of at least one of a character and a symbol; storage means for storing a bit pattern of sample bitmap data indicative of at least one of a character and a symbol and information represented by the sample bitmap data by relating the bit pattern with the information; estimation means for estimating sample bitmap data substantially identical to the bitmap data from among the sample bitmap data by comparing a bit pattern of the bitmap data with a bit pattern of the sample bitmap data; and replacement means for replacing the bitmap data by information represented by the sample bitmap data estimated identical by the estimation means.

In carrying out the invention and according to another mode thereof, there is provided a subtitle information analysis method including the steps of: separating subtitle data including bitmap data indicative of at least one of a character and a symbol; storing a bit pattern of sample bitmap data indicative of at least one of a character and a symbol and information represented by the sample bitmap data by relating the bit pattern with the information; estimating sample bitmap data substantially identical to the bitmap data from among the sample bitmap data by comparing a bit pattern of the bitmap data with a bit pattern of the sample bitmap data; and replacing the bitmap data by information represented by the sample bitmap data estimated identical in the estimation step.

As described and according to the embodiments of the present invention, by replacing DRCS by a character string using ordinary characters, DRCS can be analyzed as ordinary characters, so that contents search, scene search and digest playback and so on can be executed with a high degree of accuracy.

### BRIEF DESCRIPTION OF THE DRAWINGS

Other objects and aspects of the invention will become apparent from the following description of embodiments with reference to the accompanying drawings in which:

FIGS. 1A through 1F are diagrams illustrating examples of characters or symbols that are represented by use of DRCS;

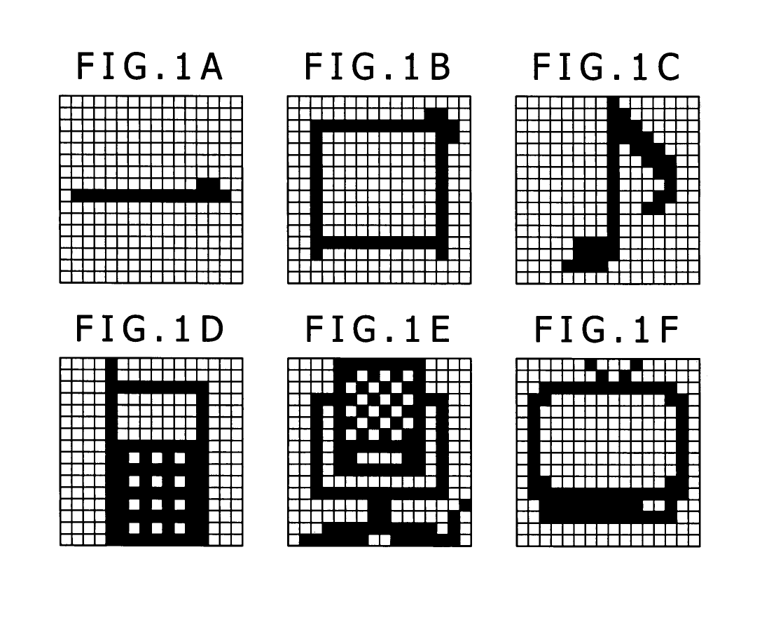

FIG. 2 is a block diagram illustrating an exemplary configuration of a subtitle information analysis apparatus practiced as one embodiment of the invention;

FIG. 3 is a diagram illustrating examples of bit patterns, context data, and appearance frequency information that are stored in a sample data storage block;

FIG. 4 is a diagram illustrating character string information that is stored in a character string storage block;

FIG. 5 is a flowchart indicative of processing that is executed by a DRCS estimation block;

FIG. 6 is a flowchart indicative of processing that is executed by a scene detection unit; and

FIG. 7 is a diagram illustrating an example of thumbnail representation as a scene detection result.

### DETAILED DESCRIPTION OF THE PREFERRED EMBODIMENTS

### Configuration of Subtitle Information Analysis Apparatus

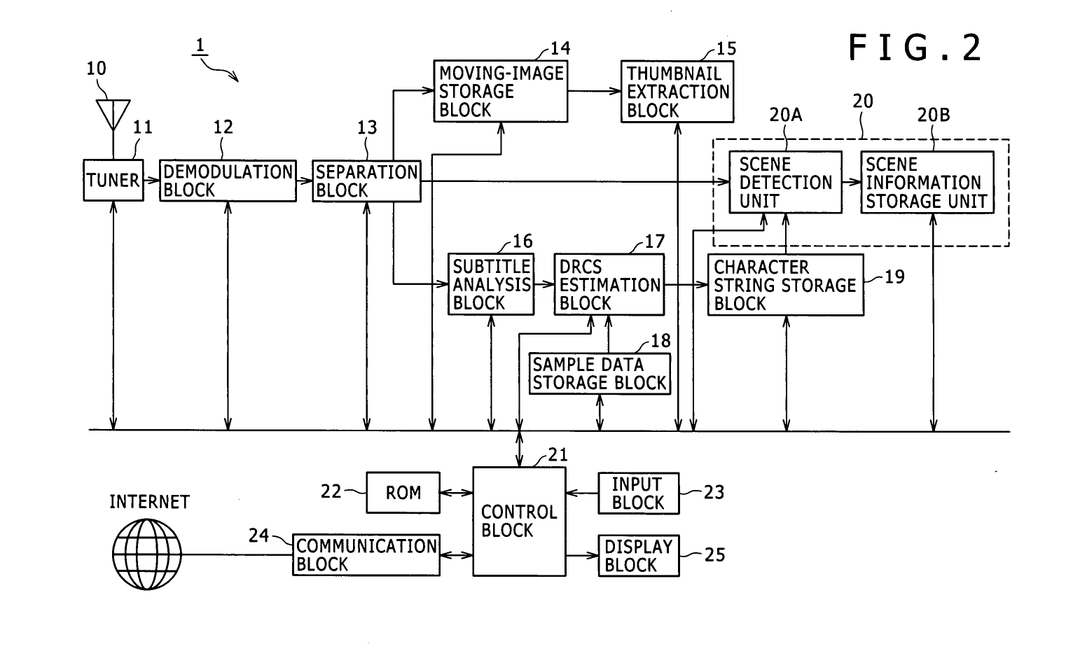

This invention will be described in further detail by way of embodiments thereof with reference to the accompanying drawings. As shown in FIG. 2, a subtitle information analysis apparatus 1 has an antenna 10, a tuner 11, a demodulation block 12, a separation block 13, a moving-image storage block 14, a thumbnail extraction block 15, a subtitle analysis block 16, a DRCS estimation block 17, a sample data storage block 18, a character string storage block 19, and an application block 20. The application block 20 has a scene detection unit 20A and a scene information storage unit 20B.

The antenna 10 receives a broadcast wave of terrestrial broadcasting. The received broadcast signal is supplied to the tuner 11 to be converted into an intermediate frequency signal. The intermediate frequency signal is supplied to the demodulation block 12. Through the demodulation block 12, a transport stream that is a moving-image stream is demodulated for extraction. The extracted transport stream is supplied to the separation block 13.

The separation block 13 includes a demultiplexer for separating a transport stream and a decoder for executing decoding. On the basis of a packet identifier (PID) written in the header part of each packet, the separation block 13 separates a transport stream into a video PES (Packetized Elementary Stream), an audio PES, a subtitle PES, PSI (Program Specific Information), and SI (Service Information). SI carries various kinds of information, such as program channel, title, start date and time, broadcast duration, detail contents, progress situation, genre, and series information, for example. Reading SI provides EPG (Electronic Program Guide) data. Video PES, audio PES, and subtitle PES include PTS (Presentation Time Stamp) that is time information for use in synchronous reproduction. The video PES, audio PES, and subtitle PES obtained as a result of the separation are signal-processed in a predetermined manner to be converted into video data, audio data, and subtitle data, respectively. Then, the video data and the audio data are supplied to the moving-image storage block 14 to be stored therein. The subtitle data is supplied to the subtitle analysis block 16.

The thumbnail extraction block 15 extracts one frame from the video data recorded to the moving-image storage block and creates a thumbnail from the extracted frame. A thumbnail extracted by the thumbnail extraction block 15 is used to display a scene detection result obtained by the scene detection unit 20A to be described later onto a display block 25. Details of this processing will be described later.

The subtitle analysis block 16 executes predetermined analysis processing on the subtitle data supplied from the separation block 13 to generate characters (hereafter referred to as ordinary characters) expressed by a JIS (Japan Industrial Standard) code format from the processed subtitle data. It should be noted that, as described above, the subtitle data may include DRCS in addition to those convertible into ordinary characters. DRCS is representative of so-called external characters, such as symbols and special characters, in bitmap data. Therefore, DRCS cannot be processed by the above-mentioned analysis processing. DRCS in subtitle data is supplied to the DRCS estimation block 17 as DRCS without change. Consequently, the character string processed by the subtitle analysis block 16, DRCS, and PTS are supplied to the DRCS estimation block 17.

If the DRCS supplied from the subtitle analysis block 16 is representative of characters, the DRCS estimation block 17 estimates what character is represented by this DRCS and then replaces this DRCS by an ordinary character represented by this DRCS. In addition, if the DRCS subject to judgment is representative of a symbol, the DRCS estimation block 17 estimates of which meaning the symbol is representative and then replaces this DRCS by a character string based on ordinary characters. The DRCS estimation block 17 is equivalent to estimation block and replacement block. In order to estimate of which character or symbol DRCS is representative, the DRCS estimation block 17 executes three types of processing, namely, pattern matching, context judgment, and selection based on appearance frequency in a subtitle (hereafter referred to as appearance frequency selection). It should be noted here that these three types of processing may not be executed at the same time; any two of the three types of processing may be executed. Details of each of these types of processing and details of DRCS replacement will be described later.

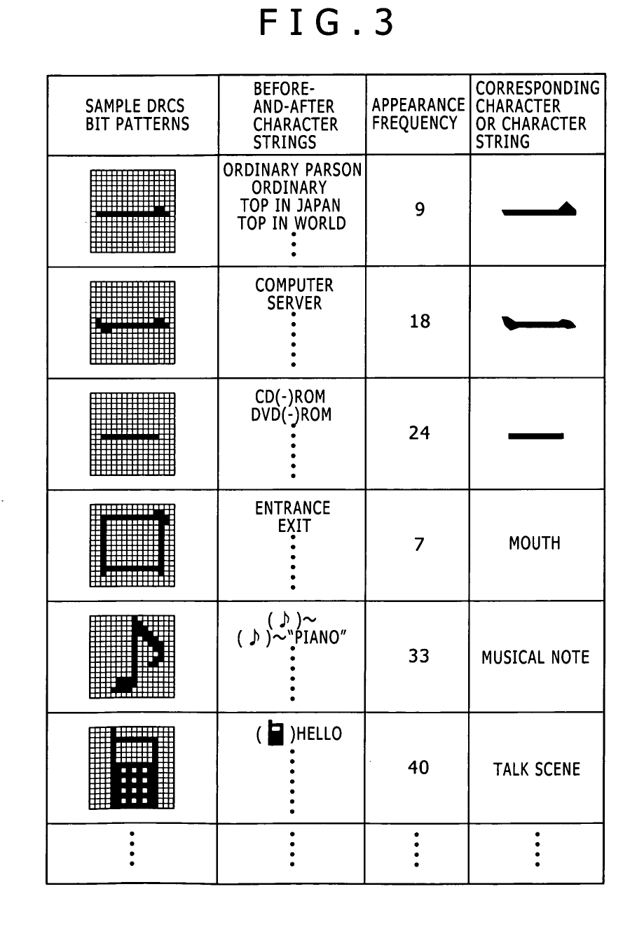

As shown in FIG. 3, the sample data storage block 18 stores bit patterns of DRCS as sample data for use in the processing to be executed by the DRCS estimation block 17 (hereafter referred to as sample DRCS), context data, and appearance frequency information. It should be noted that the bit patterns, the context data, and the appearance frequency information are stored as related with character strings composed of ordinary characters represented by this DRCS or character strings composed of ordinary characters indicative of the meaning of a symbol represented by this DRCS. If the DRCS estimation block 17 executes pattern matching, bit patterns are read. If the DRCS estimation block 17 executes context judgment, context data is read. If the DRCS estimation block 17 executes appearance frequency selection, appearance frequency information is read. It should be noted that details of these bit patterns, context data, and appearance frequency information will be described later. The bit patterns, content data, and appearance frequency information are illustrative only and therefore actual bit patterns, context data, and appearance frequency information are not limited thereto.

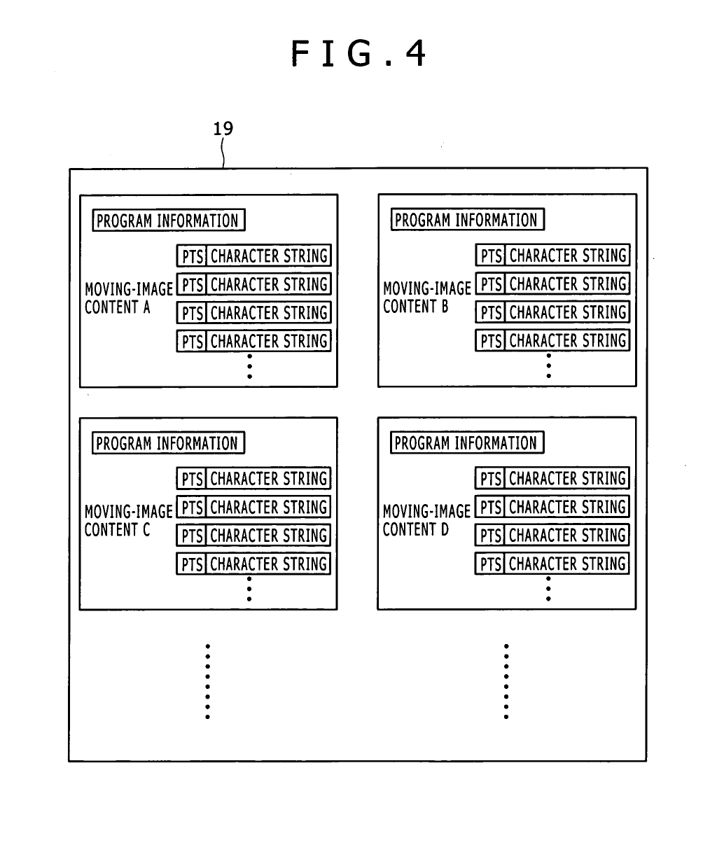

As shown in FIG. 4, the character string storage block 19 stores the ordinary characters contained in a subtitle and the ordinary characters obtained from DRCS by the DRCS estimation block 17 as related with PTS for each moving image. The character string storage block 19 also stores program information. DRCS is all replaced by ordinary characters by the DRCS estimation block 17 and only a character string composed of ordinary characters and PTS are stored in the character string storage block 19, so that various applications can be executed by the application block 20.

The application block 20 is configured by the scene detection unit 20A for detecting scenes in video content from subtitle data and the scene information storage unit 20B for storing the information about scenes detected by the scene detection unit 20A in the present embodiment of the invention. The scene detection unit 20A detects scenes in a moving image by use of a processing result of the DRCS estimation block 17 stored in the character string storage block 19. Details of the scene detection processing will be described later. The scene information storage unit 20B stores the information about scenes detected by the scene detection unit 20A.

Each of the component blocks and units of the subtitle information analysis apparatus 1 configured as described above is connected to a control block 21. The control block 21 is connected with a ROM (Read Only Memory) 22, an input block 23, a communication block 24, and the display block 25.

The control block 21 is a microcomputer based on a CPU (Central Processing Unit) and so on and controls each component block of the subtitle information analysis apparatus 1 as instructed by programs stored in the ROM 22 in advance. The input block 23 denotes various kinds of input devices, such as a remote controller, a keyboard, and so on, through which a user enters search keywords and instructions into the subtitle information analysis apparatus 1.

The communication block 24 is connected to the Internet. Through the communication block 24, the subtitle information analysis apparatus 1 is able to download bit patterns, context data, and appearance frequency information, of which details will be described later. The display block is configured by a display device based on LCD (Liquid Crystal Display), CRT (Cathode Ray Tube display), or organic EL (Electro Luminescence) and an interface thereof. Moving-image content is displayed by the display block 25. In addition, a result of the determination made by the scene detection unit 20A is extracted by the thumbnail extraction block 15 and this result is displayed on the display block 25 in a thumbnail manner.

Operations of the Subtitle Information Analysis Apparatus

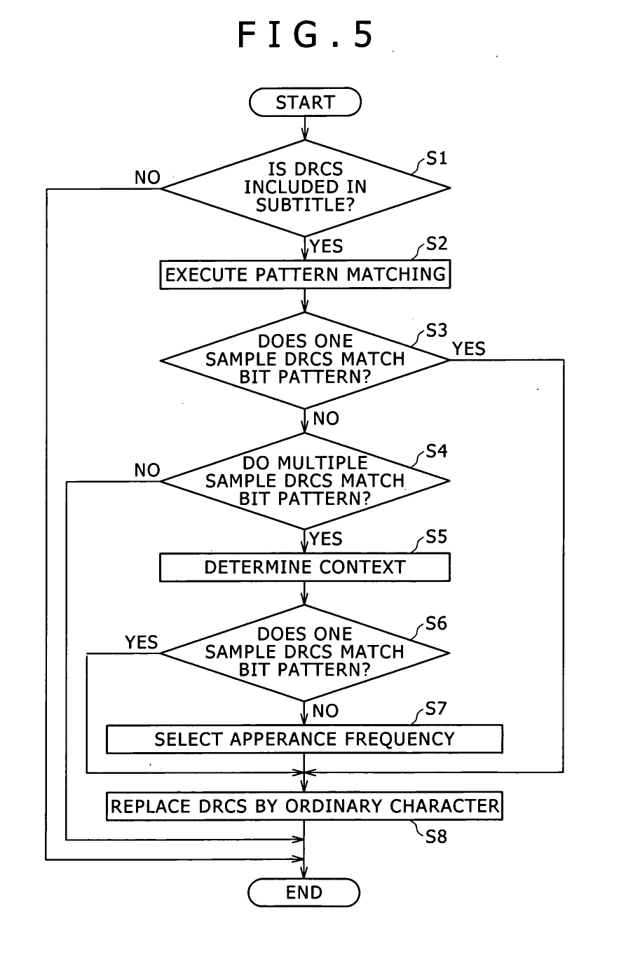

The following describes the pattern matching, context determination, appearance frequency selection, and DRCS replacement processing operations that are executed by the DRCS estimation block 17 with reference to FIGS. 3 through 5.

As shown in FIG. 3, the bit patterns, context data, and appearance frequency information of a sample DRCS for use in the processing to be executed by the DRCS estimation block 17 are stored in the sample data storage block 18 as related with characters represented by the sample DRCS or character strings indicative of the meaning of symbols.

In FIG. 3, the sample DRCS of [symbol] (- that is a kanji numeral) is related with ordinary character [symbol] (- that is a kanji numeral). [symbol] (a prolonged sound symbol) is related with ordinary character [symbol] (a prolonged sound symbol). “-” (hyphen) is related with ordinary character “-” (hyphen). If the sample DRCS is a symbol, a character string of ordinary characters allowing the easy understanding of the meaning of that symbol is related. If the sample DRCS is [symbol] then character string “musical note mark” is related. If the sample DRCS is a mobile phone mark, character string “talk scene” is related. It should be noted, however, that each character string to be related are not limited to one type; any desired types can be set in consideration of applications by the application block 20 to be described later. For example, it is practicable for [symbol] to be related with character string “music scene,” “scene with background music,” or the like, in addition to “musical note mark.” In the case of the mobile phone mark, character string “talk scene on mobile phone” may be related.

A bit pattern denotes a bit pattern of the sample DRCS that is bitmap data. Context data denotes a database of various combinations of character strings used before and after DRCS in a subtitle from movies, television programs, and so on in the past. FIG. 3 illustratively shows that character strings for use in combination with [symbol] [symbol] [symbol] [symbol] and so on are related with [symbol] (- that is a kanji numeral) and stored. Character strings for use in combination with [symbol] (a prolonged sound symbol), such as [symbol] [symbol] and so on, are related with [symbol] (a prolonged sound symbol) and stored. Character strings, such as CD(-)ROM, DVD(-)ROM, and so on, are related with “-” (hyphen) and stored. Character strings, such as [symbol] [symbol] and so on, are related with [symbol] (mouth in kanji) and stored. Character strings, such as [symbol] [symbol] ‘piano’,” and so on, are related with [symbol] (musical note mark) and stored. It should be noted that apostrophes enclosing “piano” above denote a music title or music instrument, for example. Character strings, such as “Hello” and so on, are related with “mobile phone mark” and stored.

Appearance frequency information is a database of sample DRCS ranked on the basis of the appearance frequency of DRCS in the subtitles of movies and television programs in the past. In FIG. 3, the appearance frequency is [symbol] [symbol] [symbol] and “mobile phone mark” in this order. It should be noted that appearance frequency information is not limited to the ranked appearance frequency of DRCS; for example, appearance frequency information may be appearance frequency itself.

First, the DRCS estimation block 17 determines whether DRCS is included in subtitle data (step S1). If DRCS is found in subtitle data (Yes in step S1), then the DRCS estimation block 17 executes pattern matching (step S2). It should be noted that If DRCS is not found in subtitle data (No in step S1), then the processing by the DRCS estimation block 17 comes to an end.

In pattern matching, bit patterns of sample DRCSs are read from the sample data storage block 18. A comparison is made between the bit patterns of the sample DRCS and the DRCS included in the subtitle data subject to processing (this processing is called pattern matching). The sample DRCS of two or more sample DRCS that matches the DRCS in the subtitle in pattern is estimated to be the identical DRCS. It should be noted that the matching of patterns is not limited to complete matching; for example, bit pattern matching may be attained if the number of matching pixels is higher than a certain ratio to the total number of pixels. The pattern matching is executed on all DRCSs contained in the subtitle data.

Next, after the pattern matching, the DRCS estimation block 17 determines whether there is a bit pattern match between the DRCS in the subtitle data subject to processing and one sample DRCS among two or more sample DRCSs stored in the sample data storage block 18 (step S3). If there is no match with one sample DRCS (No in step S3), then the DRCS estimation block 17 determines whether there is a bit pattern match with two or more sample DRCSs (step S4). If there is bit pattern match with two or more sample DRCS in step S4, then the DRCS estimation block 17 executes context judgment (step S5).

In executing context judgment, context data is read from the sample data storage block 18. In context judgment, a comparison is made between the context data corresponding to two or more sample DRCSs determined matching in bit pattern with the DRCS in the subtitle data by the pattern matching of step S3 and the character strings before and after the DRCS included in the subtitle data. This comparison allows the estimation that a sample DRCS among two or more sample DRCS estimated identical by the pattern matching that approximates the DRCS in the subtitle data is identical one.

The following describes a specific example of context judgment in which the DRCS subject to processing included in subtitle data is [symbol] (- that is a kanji numeral), which is used as word [symbol] in combination with a character string [symbol] When pattern matching is executed on DRCS [symbol] (- that is a kanji numeral), it is possible that the DRCS be similar to [symbol] (a prolonged sound symbol) and “-” (hyphen) in addition to [symbol] (- that is a kanji numeral) and therefore be identical to the three sample DRCSs. Therefore, a comparison is made between the context data of the three sample DRCSs [symbol] (- that is a kanji numeral), [symbol] (a prolonged sound symbol), and “-” (hyphen) that have been estimated identical and the character strings before and after [symbol] (- that is a kanji numeral) that is the DRCS in the subtitle data. In this example, the DRCS [symbol] (- that is a kanji numeral) in the subtitle data is used in combination with character string [symbol] so that it is determined that DRCS [symbol] (- that is a kanji numeral) matches [symbol] that is the context data of [symbol] (- that is a kanji numeral) that is the sample DRCS, thereby estimating that this DRCS is one of kanji numerals. Executing this processing allows the narrowing of estimation results to enhance the accuracy of the estimation even if an estimation result is obtained that the DRCS in subtitle data is determined identical to two or more sample DRCSs as a result of pattern matching.

Next, the DRCS estimation block 17 determines whether one sample DRCS has been picked up as a result of the context judgment (step S6). If one standard DRCS has not been picked up (No in step S6), namely, if the DRCS in the subtitle data is found identical to tow or more sample DRCSs as a result of the context judgment, the DRCS estimation block 17 executes appearance frequency selection next (step S7).

Appearance frequency selection estimates, if the DRCS in subtitle data is estimated identical to two or more sample DRCS by context judgment, that the sample DRCS having the highest appearance frequency among these sample DRCSs is identical to the DRCS in subtitle data. For example, with the appearance frequency information shown in FIG. 3, among the three DRCSs [symbol] (- that is a kanji numeral), [symbol] (a prolonged sound symbol), and “-” (hyphen), DRCS [symbol] (- that is a kanji numeral) has the highest appearance frequency in subtitle data. So, the appearance frequency selection estimates that DRCS [symbol] (- that is a kanji numeral) in the subtitle data is identical to the [symbol] (- that is a kanji numeral) that has the highest appearance frequency. Consequently, the DRCS in the subtitle data can be always estimated to be identical to one sample DRCS.

Next, after the appearance frequency selection, the DRCS in the subtitle data is replaced by an ordinary character related with the sample DRCS estimated identical (step S8). Also, if the DRCS in the subtitle data is estimated identical to one sample DRCS only by the pattern matching of the above-mentioned step S4, the replacement is executed in step S8. Further, if the DRCS in the subtitle data is estimated identical to one sample DRCS by the context judgment of step S5, the DRCS is also replaced by an ordinary character in step S8.

In the replacement processing of step S8, if the DRCS in the subtitle data is representative of a character, [symbol] (- that is a kanji numeral) or [symbol] (mouth in kanji),” for example, this DRCS is replaced by ordinary character [symbol] (- that is a kanji numeral) or [symbol] (mouth in kanji).” If the DRCS subject to judgment is symbol [symbol] this DRCS is replaced by character string “musical note mark” indicative of the meaning of this symbol.

Then, the DRCS estimation block 17 stores the character string of ordinary characters and the character string of ordinary characters with DRCS replaced into the character string storage block 19 as related with PTSs indicative of the display times of these character strings as character string information as classed by the types of moving-image content as shown in FIG. 4. The DRCSs included in the subtitle data are all replaced by a character string of ordinary characters by the DRCS estimation block 17, so that the character strings of ordinary characters and PTSs are stored in the character string storage block 19.

It should be noted that, in the present embodiment, bit patterns, context data, and appearance frequency information are stored in the sample data storage block 18 in advance. However, it is also practicable to store bit patterns, context data, and appearance frequency information into the sample data storage block 18 by downloading bit patterns, context data, and appearance frequency information from a server by connecting the subtitle information analysis apparatus 1 to a network such as the Internet. Updating bit patterns, context data, and appearance frequency information on the server from time to time can maintain these data and information stored in the sample data storage block 18 always in the most recent condition. Consequently, if new DRCSs not found in subtitle data are used, the subtitle information analysis apparatus 1 is promptly able to cope with such a situation.

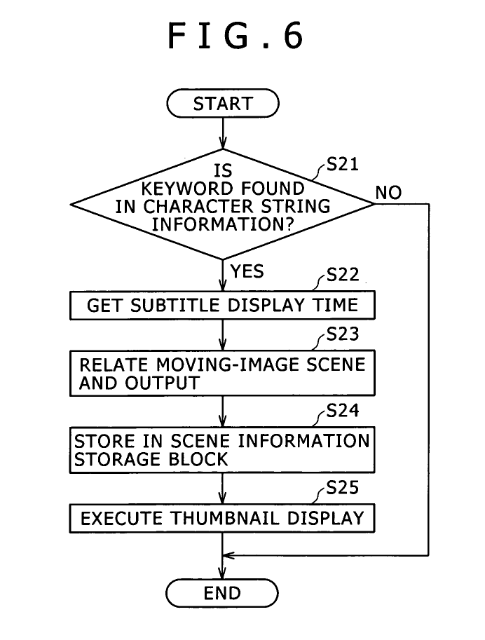

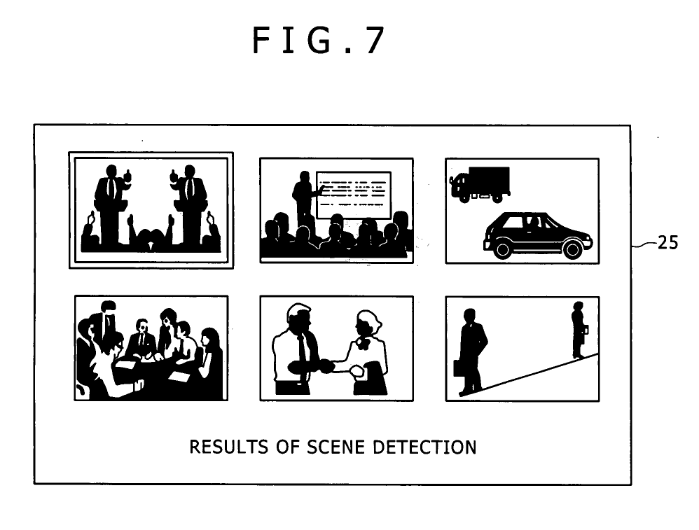

The following describes scene detection processing to be executed by the scene detection unit 20A of the application block 20 with reference to FIGS. 6 and 7. The flowchart shown in FIG. 6 is indicative of a flow of the processing to be executed after the user has entered a character in subtitle data for searching as a search keyword. The keyword input by the user is executed through the input block 23. It should be noted that the user may execute a keyword input operation when video reproduction is not executed or on the screen during video reproduction.

For the execution of scene detection, character string information with a character string and PTS indicative of a time of displaying this character string related with each other for each piece of moving-image content shown in FIG. 4 supplied from the character string storage block 19 to the scene detection unit 20A. In addition, video data and audio data are supplied from the separation block 13 to the scene detection unit 20A. Upon starting scene detection, the scene detection unit 20A references the character string information to determine whether a character string including the keyword entered by the user is included in the subtitle data (step S21). It should be noted that this determination may be made on a particular item of moving-image content specified by the user or on all character string information stored in the character string storage block 19 without specifying a particular item of moving-image content. If a character string including the keyword is not found in the subtitle data (No in step S21), the scene detection processing comes to an end assuming that there is no scene in which the subtitle data including the keyword entered by the user is displayed. It should be noted that, in doing so, a keyword similar or associated with the keyword entered by the user may be displayed on the display block 25, thereby prompting the user for entering a new keyword.

If a character string including the keyword is found in the subtitle data (Yes in step S21), the scene detection unit 20A references the PTS related with this keyword to get time information indicative of a time at which this character string is displayed (step S22). Then, by relating the AV data supplied from the separation block 13 with the time information indicative of a time at which the character string including the keyword, the time information is related with a moving-image scene at that time, the related information and moving-image scene being outputted as scene information (step S23). The outputted scene information is recorded to the scene information storage unit 20B (step S24).

Next, a result of the scene detection processing, namely, a scene in which the subtitle data including the keyword entered by the user, is related with a thumbnail extracted by the thumbnail extraction block 15 to be provided to the user as displayed on the display block 25 in a thumbnail display manner as shown in FIG. 7 (step S25).

Conventionally, the DRCS included in subtitle data is so-called external characters expressed by bitmap data, so that this DRCS is not subject to the scene detection by subtitle data. In contrast, the present embodiment replaces all DRCSs included in subtitle data are replaced by ordinary characters, so that all the characters and symbols represented by DRCSs can be made subject to keyword search processing. Therefore, as compared with related-art techniques, the accuracy of scene detection can be enhanced. In addition, for example, [symbol] (musical note mark) that is the DRCS indicative of background music in a moving image is replaced by a character string (“music scene” for example) using ordinary characters indicative of the meaning of the symbol. Consequently, by setting the keyword by the user for searching to “music scene,” a scene in which background music in a moving image is played can be detected. Thus, replacing DRCSs by ordinary characters can widen a detection method and a scene to be detected, thereby executing scene detection processing in a more detail manner.

In the present embodiment, scene detection processing has been described for example as an application to be executed by the application block 20. It should be noted here that the application to be executed is not limited to the scene detection processing. As described above, the subtitles are stored for each item of moving-image content in the scene information storage unit 20B as related with time information at which these subtitles are displayed, so that the moving-image content in which subtitles including a user-entered keyword are displayed can be searched for. Then, a result of the moving-image content search is related with a thumbnail extracted by the thumbnail extraction block 15 like a scene detection result to be displayed on the display block 25 in a thumbnail display manner for the user. This allows the user to easily find desired programs, thereby usefully providing a hard disk recorder application in which large amounts of program content can be recorded to a hard disk drive.

While preferred embodiments of the present invention have been described using specific terms, such description is for illustrative purpose, and it is to be understood that changes and variations may be made without departing from the spirit or scope of the following claims. For example, the pattern matching, the context judgment, and the appearance frequency selection to be executed by the DRCS estimation block 17 may not all executed; for example, the DRCS estimation block 17 may execute a combination of the pattern matching and the context judgment or a combination of the pattern matching and the appearance frequency selection. Further, in addition to the input of television broadcasting via the antenna 10 into the subtitle information analysis apparatus 1, moving-image content including subtitle data may be entered from a hard disk drive or a memory card via a USB (Universal Serial Bus), for example.

Further, the embodiment of the present invention is not limited to the reception of terrestrial digital broadcasting; it is also practicable to apply the embodiment to the reception of IPTV (Internet Protocol Television) services, for example. IPTV is intended to distribute digital television broadcasts by use of IP (Internet Protocol).

Still further, the embodiment of the present invention is applicable to hard disk recorders capable of storing moving-image content, personal computers, and mobile phones, for example. Yet further, the embodiment of the present invention is applicable to DVD (Digital Versatile Disc) players and BD (Blu-ray Disc) players capable of reproducing moving-image content recorded to recording media of these players. It should be noted that, in the application of the embodiment of the present invention to devices configured to record and reproduce broadcast moving-image content from hard disk recorders for example, the recording processing may be executed while the DRCS estimation block 17 is executing judgment and replacement processing. This allows the scene detection and so on by use of subtitle data upon completion of the recording of moving-image content.

It should be understood by those skilled in the art that various modifications, combinations, sub-combinations and alterations may occur depending on design requirements and other factor in so far as they are within the scope of the appended claims or the equivalents thereof.

What is claimed is:

1. A subtitle information analysis apparatus comprising:
separation means for separating subtitle data including bitmap data indicative of at least one of a character and a symbol;
storage means for storing a bit pattern of sample bitmap data indicative of at least one of a character and a symbol and information represented by said sample bitmap data by relating said bit pattern with said information;
estimation means for estimating sample bitmap data substantially identical to said bitmap data from among said sample bitmap data by comparing a bit pattern of said bitmap data with a bit pattern of said sample bitmap data; and
replacement means for replacing said bitmap data by information represented by said sample bitmap data estimated identical by said estimation means.

2. The subtitle information analysis apparatus according to claim 1, wherein
said storage means further stores a combination of characters arranged before and/or after in a subtitle of said sample bitmap data by relating said combination with the information represented by said sample bitmap data; and
said estimation means, if said bitmap data is estimated substantially identical to a plurality of pieces of said sample bitmap data, further makes a comparison between character combinations arranged before and/or after in the subtitle of said plurality of pieces of sample bitmap data estimated substantially identical and said bitmap data, thereby estimating sample bitmap data substantially identical to said bitmap data from among said sample bitmap data.

3. The subtitle information analysis apparatus according to claim 1, wherein
said storage means further stores an appearance frequency of said sample bitmap data in a subtitle and the information represented by said sample bitmap data by relating said appearance frequency with said information represented by said sample bitmap data; and
said estimation means, if said bitmap data is estimated substantially identical to the plurality pieces of said sample bitmap data, further selects sample bitmap data having a highest appearance frequency from among the plurality pieces of said sample bitmap data estimated substantially identical, thereby estimating sample bitmap data substantially identical to said bitmap data from among said sample bitmap data.

4. The subtitle information analysis apparatus according to claim 1, wherein, if said sample bitmap data is representative of a character, said information is this character and, if said bitmap data is representative of a symbol, said information is representative of a character string represented by this symbol.

5. The subtitle information analysis apparatus according to claim 1, further comprising:
communication means for connecting said subtitle information analysis apparatus to a network, through which the bit pattern of said sample bitmap data, the combination of characters arranged before and/or after in a subtitle, the appearance frequency in a subtitle, and information represented by said bitmap data in order to update the bit pattern of said sample bitmap data, the combination of characters arranged before and/or after in a subtitle, the appearance frequency in a subtitle, and information represented by said bitmap data.

6. A subtitle information analysis method comprising the steps of:
separating subtitle data including bitmap data indicative of at least one of a character and a symbol;
storing a bit pattern of sample bitmap data indicative of at least one of a character and a symbol and information represented by said sample bitmap data by relating said bit pattern with said information;
estimating sample bitmap data substantially identical to said bitmap data from among said sample bitmap data by comparing a bit pattern of said bitmap data with a bit pattern of said sample bitmap data; and
replacing said bitmap data by information represented by said sample bitmap data estimated identical in said estimation step.

7. A subtitle information analysis apparatus comprising:
a separator configured to separate subtitle data including bitmap data indicative of at least one of a character and a symbol;
a storage configured to store a bit pattern of sample bitmap data indicative of at least one of a character and a symbol and information represented by said sample bitmap data by relating said bit pattern with said information;
an estimator configured to estimate sample bitmap data substantially identical to said bitmap data from among said sample bitmap data by comparing a bit pattern of said bitmap data with a bit pattern of said sample bitmap data; and
a replacer configured to replace said bitmap data by information represented by said sample bitmap data estimated identical by said estimator.
